(19) United States
(12) Patent Application Publication
(10) Pub. No.: US 2009/0201159 A1
(43) Pub. Date: Aug. 13, 2009

(54) Method and device for determining information on an animal and/or animal milk

(76) Inventors: Peter Kaever, Trossingen (DE); Olaf Suhr, Oelde (DE); Reinhard Frenser, Rheda-Wiedenbrück (DE); Andreas Hölderlin, Besigheim (DE)

Correspondence Address: SMITH LAW OFFICE, 8000 EXCELSIOR DRIVE, SUITE 301, MADISON, WI, 53717, US

(21) Appl. No.: 11/921,800

(22) PCT Filed: Jun. 9, 2006
(86) PCT No.: PCT/EP2006/005543

§ 371 Date: Apr. 3, 2009

(30) Foreign Application Priority Data
Jun. 10, 2005 (DE) 10 2005 026 877.3

(51) Int. Cl. G08B 23/00; A01J 5/00

(52) U.S. Cl. 340/573.1; 119/14.02

(57) ABSTRACT

The method according to the invention for determining information on an animal and/or animal milk, in which a sensor unit detects four items of data relating to the health, well-being and/or behaviour of the animal and/or data relating to the quality or composition of the animal milk and/or data relating to a physical, chemical, biological and/or morphological property of the animal milk and uses a transmitting and/or receiving unit (6) to wirelessly transmit said data to a central data unit (10), is distinguished by the fact that activation and/or signalling for data transmission is/are effected separately from the actual data transmission. The method according to the invention, the device according to the invention which has been set up to carry out, and is suitable for carrying out, the method according to the invention and the milking installation and herd management installation having this device according to the invention make it possible to determine information on an animal and/or animal milk in an energy-saving manner, thus achieving comparatively long operating times and thus reliable operation.

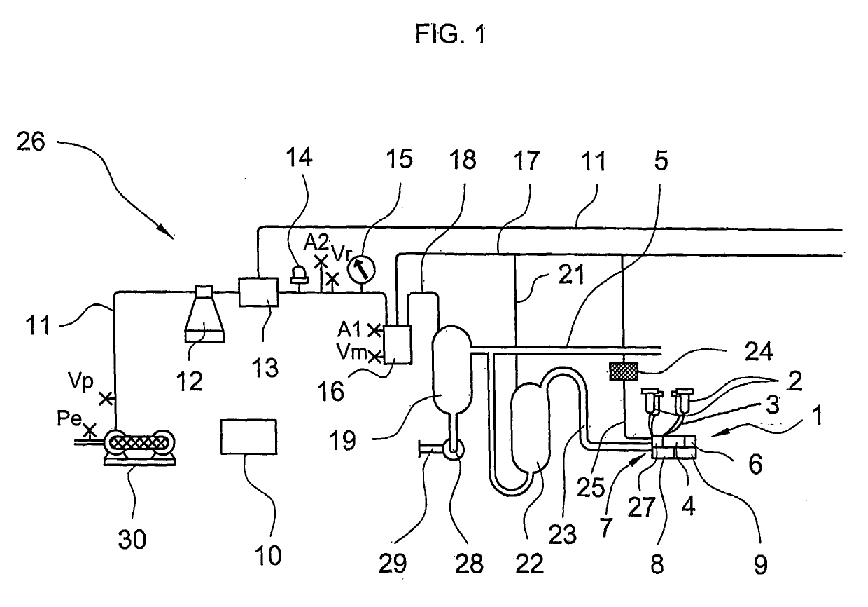

The present invention relates to a method and a device for providing information on an animal and/or animal milk, wherein a sensor unit detects data relating to the health, well-being and/or behavior of the animal and/or data relating to the quality or composition of the animal milk and/or data relating to a physical, chemical, biological and/or morphological property of the animal milk and transmits said data wirelessly to a central data station with the aid of a transmitting and/or receiving unit, and relates to a milking installation and a herd management installation.

In the context of constant endeavors to automate the milking of animals, in particular cows, sheep or goats, or to monitor individual animals or all animals in a herd better and more comprehensively, sensors that gather information on the state of health of an animal or data relating to the quality and/or composition of the animal milk are being used to an increased extent.

By way of example, with the aid of a sensor carried around by a cow itself, the movement behavior of the cow can be monitored and conclusions about the cow's state of health can be drawn from this. It is also known to implant a sensor in an animal, which sensor measures an animal's body temperature and relays the latter wirelessly by means of a transponder to a stationary receiving unit.

Furthermore, it is known for milk that has been milked in an udder-quarter-specific manner to be examined during milking with regard to somatic cells, conductivity, color or flow rate, and for the information obtained to be forwarded to a central data station. For this purpose, it is possible to measure sensor-based information near the milk collecting piece.

EP 0 534 564 A2 reveals that known solutions require a high power demand and there is the need for the sensor unit to be cabled in order to supply the latter with sufficient energy for a minimum operating duration that is desired in practice. In the case of comprehensive monitoring of a large number of animals or directly on the animal, cabling is impractical and the use of wireless or cableless transmission techniques is desirable.

Radio transmission systems make use of mobile units and stationary units. When batteries or rechargeable batteries are used as energy source in a wireless transmission system, the operating duration of the mobile components depends greatly on how the transmission system is operated. The provision of the energy required for the sensor system and the transmission thus poses a particular problem.

The object established is to overcome the known disadvantages in the prior art and to provide a method for determining information on an animal and/or animal milk by means of a wireless transmission system which enables the wirelessly connected transmitting and receiving devices to have an operating duration that is as long as possible.

This object is achieved by means of a method as specified in claim 1. The dependent claims relate to particular developments and advantageous embodiments which can be combined in each case individually or arbitrarily with one another.

In the method according to the invention for determining information on an animal and/or animal milk, wherein a sensor unit detects data relating to the health, well-being, e.g. heat, and/or behavior of the animal and/or data relating to the quality or composition of the animal milk and/or data relating to a physical, chemical, biological and/or morphological property of the animal milk and transmits said data wirelessly to a central data station with the aid of a transmitting and/or receiving unit, activation and/or signaling for the data transmission are/is effected separately from the actual data transmission.

The method provides for reducing the central problem of the limited supply of energy for the wireless transmission by means of a particular efficiency in the organization of the data transmission. By separating activation and/or signaling for the data transmission, on the one hand, and the actual data transmission, on the other hand, it is possible to reduce collisions on the radio link between a plurality of sensors, which lead to erroneous data transmissions and thus to repetitions in the data transmission, and so less current is required as a result. The separation between activation and/or signaling, on the one hand, and the data transmission, on the other hand, enables the data transmission process to be configured efficiently by virtue of the individual data transmission of an individual sensor unit being effected in concert with the data transmissions of other sensor units.

Activation is understood to be that process which puts the transmitting and/or receiving unit into a state that enables it to start the actual data transmission. Activation is a targeted operation that converts the transmitting and/or receiving unit into the data transmission state at a specific point in time or within a specific period of time. If a plurality of transmitting and/or receiving units are provided, then the activation can also be effected selectively, spatially or logically locally. In this case, individual transmitting and/or receiving units can be activated successively and/or in overlapping fashion as seen temporally. The activation enables data to be called up in a coordinated manner from different units, wherein in particular the units are formed in such a way that the information can also be transmitted simultaneously. Activation can encompass the process of setting up communication in order that the transmitting and/or receiving unit can start the actual data transmission, that is to say the transmission of the useful data.

Useful data are the data determined by the sensor unit which are intended to be transmitted. Said data can be at least partly conditioned or processed further.

Signaling is generally taken to mean the data exchange for the organization of the radio transmission and may encompass not only activation and setting up communication but also the organization of future setting up of communication, the organization of the available physical channels in the case of a multiplicity of transmission connections to be set up, the organization of a so-called handover if a mobile transmitting and/or receiving unit leaves an area controlled by a first base station and enters into an area controlled by a second base station, acknowledgement of reception, inter alia. Therefore, signaling for the data transmission is taken to mean all of the operations which are required between the transmitting and/or receiving unit and a central data station in order to organize the transmission of the useful data in order that this can start or be carried out.

The sensor unit can be used in an animal-specific manner, in particular in a quarter-udder-specific manner. The sensor unit can be arranged in proximity to or directly at the milking cup, collecting piece or milk hose. It can also be arranged at or in the body of the animal.

Sensor-based parameters can be conductivity, temperature, pH value, number of cells, impedance, color or reflection/transmission spectrum of the milk, milk constituents, urea, milk flow rate, viscosity, blood values, and others. The sensor-based parameters of the milk are preferably detected. The sensor-based data include the cell content, in particular the cell content of the somatic cells in milk. With regard to the fact that milk is a significant basic foodstuff, it is particularly important to avoid inhibitors in the milk. The inhibitors may be those which inhibit or delay enzyme reactions. The inhibitors include antibiotics, inter alia. According to the milk quality regulation, the milk contains inhibitors if, in a standardized test method, it inhibits a test microbe at least to the same extent as milk having a concentration of 0.004 μg/ml sodium benzyl penicillin. The inhibitor test prescribed by the milk quality regulation does not, however, distinguish between specific inhibitors which have the effect of killing or inhibiting micro-organisms. Medicaments need not necessarily be involved in this case. Milk from severely inflamed udder quarters can likewise react positively in the inhibitor test e.g. by virtue of enzymes that it contains. As long as the milk is given a positive rating in the inhibitor test, it must not be transferred to the dairy since it is not marketable and is to be disposed of safely.

Besides the avoidance of inhibitors within the milk, it is possible to effect the determination of adenosine triphosphate (ATP), lactate dehydrogenase (LDH), N-acetyl-β-D-glucosaminidase activity (NAGase).

A method implementation involving a combination of the data with the animal information or with data that ensure unambiguous traceability of the animal is particularly preferred. The data can be provided and/or communicated as a tuple. The communication preferably takes place to a herd management system in which the data are combined and/or stored. From the data made available, decisions can be derived by means of the herd management system. Said decisions can be used for controlling and/or regulating a milking installation.

The measurement may furthermore relate to the detection of control information for milking operations such as e.g. the attachment signal of the operator, the end of milking signal or a signal which represents the removal of the milking cluster or of a milking cup. Furthermore, the measurement can relate to the detection of control information for herd management in the broadest sense, wherein all physical, chemical, biological information on the individual animals, the feeding thereof or the animal milk thereof can be collected.

The method can be used both for controlling and for regulating a milking process or herd management. The separation between activation/signaling and the actual data transmission results in an efficiency which enables the wireless transmission systems to be operated considerably longer.

In one development, the signaling and/or the data transmission are/is effected using a radiofrequency field, an infrared frequency field and/or ultrasonic frequency field. The data transmission from the transmitting and/or receiving unit to the central data station is preferably effected by means of HF radio. The activation of the sensor unit and/or the signaling for the data transmission can be effected by means of ultrasound.

By using ultrasound for the activation and/or the signaling, it is possible for the transmission system to be operated in a manner largely free of collisions. In this case, it is also possible in particular to utilize the different propagation times of the ultrasound from the stationary unit in particular from the central data station, to the sensor units in order to activate the sensor units at different instants. If collisions nevertheless occur, it is possible to wait during a time duration that lasts for a different period of time for each sensor unit or transmitting and/or receiving unit, which can be generated for example from the ID of the sensor unit. This reduces the probability of further collisions.

As an alternative, the transmitting and/or receiving unit can be activated via radio, wherein the rate at which the sensor unit listens on the signaling channel is significantly lower than during milking. If the sensor unit hears the request of an activation for the start of milking, then it transmits its sensor identification unit (ID), whereupon the stationary unit replies with a time duration when the sensor unit is to report again with its sensor ID. Said time duration is used by the stationary unit to specify the expected point in time of a first measurement. Said point in time can be essentially at the start of milking or after preliminary milking. Furthermore, the sensor unit can listen in on the channel again after a first waiting time in order to find out a second waiting time. This can be continued until the point in time of a first expedient measurement can be designated. As an alternative, the stationary unit can be permanently ready to receive if it is provided with or connected to an energy supply.

In one advantageous development, the signaling and the data transmission are effected on physically different channels. Physically different can be effected by means of a different frequency channel, a different time slot, a different code or a different time frame. It is also possible to choose different types of transmission, in particular HF radio, infrared or ultrasound.

The data are detected in an animal-specific manner, in particular in an udder-quarter-specific manner. An udder-quarter-specific data detection is advantageous particularly for ascertaining mastitis diseases on a cow's udder. Sensor units which detect the temperature of an animal or the movement of an animal communicate the data in an animal-specific manner.

Advantageously, the sensor unit and/or the transmitting and/or receiving unit are/is supplied with energy from a battery and/or from a rechargeable battery. The sensor unit and/or the transmitting and/or receiving unit can also be configured as transponder that passively draws its energy from an external radiation field, in particular reacts to an external radiation field, in particular an HF radiation field or an ultrasonic radiation field.

The energy for the sensor unit and/or the transmitting and/or receiving unit can also be generated by a generator assigned to the unit, wherein in particular the energy is obtained from a pulse vacuum, from an ultrasonic field, from the kinetic energy of the sensor unit, and/or from the kinetic energy of the transmitting unit and/or receiving unit. In this case, the required energy is obtained in direct proximity to the transmitting and/or receiving unit and/or the sensor unit, thereby obviating cabling of the transmitting and/or receiving unit with a fixedly installed external source of electrical energy.

The signaling and/or the activation are/is advantageously effected after an adjustable waiting time. By means of the waiting time, the transmitting and/or receiving unit is put into a waiting status, which is particularly energy-saving because the transmitting and/or receiving unit does not have to listen to potentially incoming signals.

The data are advantageously transmitted in time division multiplexed, frequency division multiplexed and/or code division multiplexed fashion. During the milking time, a constant activation rate may be present, that is to say that the data are transmitted at regular intervals to the central data station. An activation rate can be predetermined at the beginning of a reporting message. The activation can be ended by the central data station, in which case it can also control individual time phases.

The data are advantageously transmitted in data packets in packet-switched fashion, in particular using an ALOHA access method. The data can be communicated irregularly in data packets. A packet-switched network permits high efficiencies for the network resources by virtue of its property of providing capacities on request.

ALOHA is an expression from the field of computer networks and describes a stochastic access method in networks without channel scanning. A time-dependent (subdivided) and a time-independent (pure) method can be chosen in this case.

In the case of a pure ALOHA, each transmitting unit can send its data packet (e.g. always having the same length) at an arbitrary point in time; if a plurality of transmitting units simultaneously send a packet, then these packets collide and are corrupted and have to be retransmitted later; each subscriber has to wait for a randomly determined period of time for the retransmission.

In contrast to pure ALOHA, in time-dependent (slotted) ALOHA a transmitting unit is not permitted to transmit at an arbitrary point in time, but rather has to keep to fixedly predetermined time intervals. This makes it possible to obtain a considerably increased throughput, corresponding to a doubling by comparison with pure ALOHA.

After transmission of the sensor data, e.g. the milking data, to a central data station, the central data station can communicate an acknowledgement of data receipt to the transmitting and/or receiving unit and in this case can transmit the next time duration until the next measurement. In this case, the transmitting and/or receiving unit listens in on the data transmission channel until the acknowledgement and becomes inactive once it has received the next waiting time. The waiting times of the individual sensor units can be chosen in such a way that essentially no collisions occur for the sensor units; the time-dependent ALOHA access method described above is particularly advantageous with a large number of sensor units.

A further access method is provided by CSMA/CD (Carrier Sense Multiple Access with Collision Detection) and can likewise be used here.

The data are advantageously detected during the milking operation.

A method in which the activation is effected in a manner dependent on at least one predetermined parameter is particularly preferred. The parameter can be for example specific points in time or time intervals between two successive transmissions or other temporally relevant events. The parameter or the parameters is/are preferably stored in a central control unit by means of which the activation of the transmitting and/or receiving unit is effected. The parameters can be characteristic quantities or events. The events include for example the beginning of a milking operation, the end of a milking operation, changes within the milk flow curve, etc.

Furthermore, it is an object of the present invention to provide a device with which information on an animal and/or animal milk can be gathered and transmitted wirelessly, wherein the device is particularly energy-saving, such that it has an operating duration that is as long as possible.

This object is achieved according to the invention by means of a device for determining information on an animal and/or animal milk as specified in independent claim 12. The subclaims relate to particular developments and advantageous configurations which can be applied individually in each case or be combined arbitrarily with one another.

The device according to the invention for determining information on an animal and/or animal milk comprises at least one sensor unit for detecting data relating to the health and/or behavior of the animal and/or data relating to the quality or composition of the animal milk and/or data relating to a physical, chemical, biological and/or morphological property of the animal milk, and at least one transmitting and/or receiving unit which communicates with the sensor unit and by means of which the data can be transmitted wirelessly to a central data station, wherein the transmitting and/or receiving unit has at least one traffic channel for the transmission of data and at least one signaling channel for the activation and/or signaling of the data transmission.

The traffic channel and the signaling channel can be formed by corresponding physical or logical data channels. The traffic channel is used for transmitting the useful data streams. A useful data stream comprises for example the, if appropriate further-processed, data determined by the sensor unit or data from the central data station to the sensor unit for controlling the measurement.

The control and the management of the wireless transmission network are realized with the aid of the signaling channels. Advantageously, the traffic channels are configured in unidirectional fashion from the transmitting and/or receiving unit toward the central data station and the signaling channels are configured in bidirectional fashion. The traffic channels and the signaling channels can be embodied in the form of a corresponding multiplex method, but can also be based on different modes of transmission, such as e.g. the use of ultrasound, infrared and/or HF radio.

The transmitting and/or receiving unit can be set up as a mobile station. By way of example, it is fixed directly to or in the animal, in which case it is advantageously configured as a transponder.

Transponders can be carried as bolus, ear tag, injected material or as conventional transponders carried on the foot or neck, in the rumen, on the udder or on the teat, or subcutaneously or at other suitable locations. This applies to transponders that are carried permanently or temporarily by the animal. The transponders can communicate not only animal-specific data but also further sensor-based functions involving for example activity values, pH values or temperature values. Furthermore, sensor-based values or other values can also be communicated by means of the transponders. The contactless communication between the transponder and a reader can operate according to the radiofrequency method (RF method). There is also the possibility of the transponder operating in the microwave range.

In one development, the device comprises at least one milking cup and at least one milk hose, wherein the milking cup can be connected to a milk line via the milk hose, and the sensor unit is arranged at the milking cup, the milk hose and/or at a connecting piece between milking cup and milk line. In this case, although the transmitting and/or receiving unit is not completely mobile, since it is fixed to the milking cup, the milk hose and/or the connecting parts, all cabling outlay that would arise in parallel with the milk hoses or the milk line is obviated on account of the wireless transmission. The wireless mode of transmission also permits a rapid exchange of the transmitting and/or receiving unit and/or the sensor unit, thereby enabling said unit to be arranged at a different milking stall in a simple manner.

Advantageously, the traffic channel and the signaling channel are physically different. This can be brought about by the traffic channel using a frequency range which is different from that of the signaling channel.

Moreover, ultrasound or infrared radiation can be used for the signaling channel, while the traffic channel uses HF radio. It is also possible to assign different time slots to the traffic and/or signaling channels, such that they can use the same frequency interval, for example, without being able to have an adverse effect on one another.

The traffic channel and/or the signaling channel are/is set up for radio frequencies, infrared frequencies and/or ultrasound.

In one advantageous configuration, the transmitting and/or receiving unit has at least one of the following features (b1) to (b3): (b1) the transmitting and/or receiving unit has a battery or a rechargeable battery; (b2) the transmitting and/or receiving unit has a generator for obtaining energy, wherein in particular the generator can utilize the energy of a vacuum in the milk, of an ultrasonic field, of a kinetic energy of the sensor unit, and/or of a kinetic energy of the transmitting and/or receiving unit; (b3) the transmitting and/or receiving unit has a timing circuit for setting waiting times until the activation of the signaling channel and/or traffic channel.

In this case, it is particularly advantageous to use a rechargeable battery in connection with energy recovery, particularly if a vacuum in the milk is utilized. Energy recovery from an ultrasonic field likewise suffices for many applications in order to supply transmitting and/or receiving units at a milking installation with enough energy. In one specific configuration, the kinetic energy of the transmitting and/or receiving unit and/or that of the sensor unit are/is used to drive a small generator which supplies the transmitting and/or receiving unit and/or the sensor unit with energy.

In one particular configuration, the transmitting and/or receiving unit is configured as a passive transponder, such that it itself does not require a dedicated energy supply and is supplied via an external energy field. Low-frequency alternating electromagnetic fields are appropriate here.

Advantageously, the traffic channel and/or the signaling channel are/is set up for time division multiplexing, frequency division multiplexing and/or code division multiplexing. It is particularly preferred, however, for the traffic channel and the signaling channel to use different frequency ranges in each case, whereby a separation between the two channels is possible in a simple manner.

The transmitting and/or receiving unit can support a packet-switched network, wherein in particular a packet-switched network with an ALOHA access is realized. It is furthermore proposed to use the ZIGBEE transmission standard for the realization. Packet-switched networks have a high efficiency in respect of resources, and it is possible in a simple manner to add additional transmitting and/or receiving units, which, for their part, only require a corresponding network identification. A packet-switched network thus makes it possible, in a simple manner, to flexibly adapt the number of sensor units to the specific conditions in accordance with the requirements of a herd management or a milking process.

It is furthermore an object of the present invention to develop a known milking installation or a known milking robot and also a known herd management installation in such a way as to enable comprehensive collection of data with regard to information on the health of animals or quality and composition of animal milk, wherein the disadvantages mentioned in the introduction in connection with wirelessly connected transmitting devices are overcome.

This object is achieved by means of the milking installation or milking robot according to the invention and by means of the herd management installation as specified in the independent claims.

The milking installation, in particular milking robot, according to the invention comprises a multiplicity of milking cups, milk hoses, at least one milk line and at least one tank and has a device according to the invention as described above.

Such a milking installation can without any problems cope with the milking process for herds of cows numbering at least 50, in particular at least 100, particularly preferably 150, individuals, wherein each cow can be comprehensively individually detected in terms of data technology.

The herd management installation according to the invention comprises the device according to the invention and/or the milking installation according to the invention. A herd management installation can manage not only a milking process but also further organization of the herd, in particular with regard to feeding, shed organization, health monitoring and breeding strategy. In this case, the herd management can also encompass peripheral processes such as e.g. the organization and provision of materials or feed or veterinary care and further operational processes.

The invention will be elucidated in more detail in the drawing that follows, where the drawing is not intended to restrict the invention, but rather is only intended to illustrate the invention by way of example.

The FIGURE schematically shows part of a milking installation according to the invention comprising a device according to the invention for determining information on an animal and/or animal milk. The milking installation 26 illustrated has a separate milk and air transport and comprises a multiplicity of milking cups 2, which are fluid-conductively connected to a milk line 5 via a long milk hose 23 via a measuring container 22, wherein the milk line 5 is connected to a milk separator 19, which is connected to an overflow protection 16 via a milk separator airline 18. The overflow protection 16 is connected to a milking vacuum line 17, into which leads a milking vacuum hose 21 from the measuring container 22. A vacuum gauge 15 is used to measure the vacuum between the overflow protection 16 and an equalizing container 13, said vacuum being set with the aid of a regulating unit 14. The equalizing container 13 is connected to a pulsator airline 11 and a vacuum tank 12, which communicates with a vacuum pump 30 via the pulsator airline 11. The pulsator airline 11 is connected to a pulsator 24, which is connected via a long pulse hose 25 to a collecting piece 27 for four milking cups 2. The milk separator 19 is fluid-conductively connected to a milk sluice pump 28 and a milk pressure line 29. A transmitting and/or receiving unit 6 is fixed to the collecting piece 27, which constitutes a connecting piece 7 between milking cup 2 and milk line 5, said unit communicating with a sensor unit 4; the data relating to the composition of the milk are gathered in an udder-quarter-specific manner at the milking cups 2. The energy for the transmitting and/or receiving unit 6 is supplied by a rechargeable battery 8, which is charged by a generator 9. The generator 9 uses the vacuum pressure in the long pulse hose 25 to generate a voltage. With the aid of the sensor unit 4 and the transmitting and receiving unit 6, data relating to the quality or composition of the animal milk can be transmitted wirelessly to a central data station 10, wherein the activation and/or the signaling for the data transmission are/is effected separately from the actual data transmission. In particular, the signaling channel is used to clarify when, at what frequency and how a data transmission is effected on the traffic channel. In particular, the transmitting and/or receiving unit 6 in interaction with the central data station 10, by means of the signaling channel, negotiates when the transmitting and/or receiving unit is activated. The separation between traffic channel and signaling channel enables efficient organization of a network having a multiplicity of transmitting units, a data collision being avoided, such that an energy-saving operation is made possible overall. The energy-saving operation leads to longer operating durations of the mobile transmitting units even though the latter are not fed by an external energy supply.

The sensor unit 4 detects the so-called SCC value (somatic cell count) and the conductivity of the milk. Furthermore, the sensor unit 4 detects the flow quantity for time, that is to say the flow rate, during the milking operation. The data thus detected are then communicated to the central data station 10 via the traffic channel. The central data station 10 uses this information in the context of herd management, evaluates it and regulates the milking process or organizes further aspects of herd management, in particular the feeding of the animals.

The method according to the invention for determining information on an animal and/or animal milk, wherein a sensor unit 4 detects data relating to the quality and composition of the animal milk and/or data relating to a physical, chemical, biological and/or morphological property of the animal milk and transmits them wirelessly to a central data station 10 with the aid of a transmitting and/or receiving unit 6, is distinguished by the fact that activation and/or signaling for the data transmission are/is effected separately from the actual data transmission. The method according to the invention, the device according to the invention that is suitable and set up for carrying out the method according to the invention, and the milking installation and herd management installation having said device according to the invention enable information on an animal and/or animal milk to be determined in an energy-saving manner, such that comparatively long operating times and hence reliable operation are obtained.

### List of Reference Symbols

1 Device

2 Milking cup

3 Milk hose

4 Sensor unit

5 Milk line

6 Transmitting and/or receiving unit

7 Connecting piece

8 Rechargeable battery

9 Generator

10 Central data station

11 Pulsator airline

12 Vacuum tank

13 Equalizing container

14 Regulating unit

15 Vacuum gauge

16 Overflow protection

17 Milking vacuum line

18 Milk separator airline

19 Measuring container

21 Milking vacuum hose

22 Measuring container

23 Long milk hose

24 Pulsator

25 Long pulse hose

26 Milking installation

27 Collecting piece

28 Milk sluice pump

29 Milk pressure line

30 Vacuum pump

1. A method for determining information on an animal and/or animal milk, wherein a sensor unit (4) detects data relating to the health, well-being and/or behavior of the animal and/or
data relating to the quality or composition of the animal milk and/or
data relating to a physical, chemical, biological and/or morphological property of the animal milk and transmits said data wirelessly to a central data station (10) with the aid of a transmitting and/or receiving unit (6),
characterized in that
activation and/or signalling for the data transmission are/is effected separately from the actual data transmission.

2. The method as claimed in claim 1, characterized in that the signaling and/or the data transmission are/is effected using a radiofrequency filed, an infrared frequency field and/or ultrasonic frequency field.

3. The method as claimed in claim 1 or 2, characterized in that the signaling and the data transmission are effected on physically or logically different channels.

4. The method as claimed in one of the preceding claims, characterized in that the data are detected in an animal-specific manner, in particular in an udder-quarter-specific manner.

5. The method as claimed in one of the preceding claims, characterized in that the sensor unit (4) and/or the transmitting and/or receiving unit (6) are/is supplied with energy from a battery and/or rechargeable battery (8), in particular the sensor unit (4) and/or the transmitting and/or receiving unit (6) are/is configured as transponder.

6. The method as claimed in one of the preceding claims, characterized in that the energy for the sensor unit (4) and/or the transmitting and/or receiving unit (6) is generated by a generator (9) electrically connected thereto, wherein in particular the energy is obtained from the milk vacuum, from an ultrasonic field, from the kinetic energy of the sensor unit, and/or from the kinetic energy of the transmitting and/or receiving unit (6).

7. the method as claimed in one of the preceding claims, characterized in that the signaling is effected after an adjustable waiting time.

8. the method as claimed in one of the preceding claims, characterized in that the data are transmitted in time division multiplexed, frequency division multiplexed and/or code division multiplexed fashion.

9. The method as claimed in one of the preceding claims, characterized in that the data are transmitted in data packets in packet-switched fashion, in particular using an ALOHA access method, or else the ZIGBEE standard.

10. The method as claimed in one of the preceding claims, characterized in that the data are detected during milking.

11. The method as claimed in at least one of claims 1 to 10, in which h the activation is effected in a manner dependent on at least one predetermined parameter, in particular at predetermined points in time.

12. A device (1) for determining information on an animal an/or animal milk, comprising
at least one sensor unit (4) for detecting
data relating to the health, well-being and/or behavior of the animal and/or
data relating to the quality or composition of the animal milk and/or
data relating to a physical, chemical, biological and/or morphological property of the animal milk, and at least one transmitting an/or receiving unit (6) which communicates with the sensor unit (4) and by means of which the data can be transmitted wirelessly to a central data station (10)
characterized in that
the transmitting and/or receiving unit (6) has at least one traffic channel for the transmission of data and at least one signaling channel for the activation and/or signaling of the data transmission.

13. The device as claimed in claim 12, characterized in that the transmitting and/or receiving unit (6) is set up as a mobile station.

14. The device as claimed in claim 12 or 13, characterized by at least one milking cup (2) and at least one milk hose (3), wherein the milking cup (2) can be connected to a milk line (5) via the milk hose (3), and the sensor unit (4) is arranged at the milking cup (2), the milk hose (3) and/or at a connecting piece (7) between milking cup (2) and milk line (5).

15. The device (1) as claimed in one of claims 12, 13 or 14, characterized in that the traffic channel and the signaling channel are physically different.

16. The device (1) as claimed in one of claims 12 to 15, characterized in that the traffic channel and/or the signaling channel are/is set up for radio frequencies, infrared frequencies and/or ultrasound.

17. The device (1) as claimed in one of claims 12 to 16, characterized in that the transmitting and/or receiving unit (6) has at least one of the following features (b1) to (b3):
(b1) the transmitting an/or receiving unit (6) has a battery or a rechargeable battery (8);
(b2) the transmitting and/or receiving unit (6) has a generator (9) for obtaining energy, wherein in particular the generator (9) can utilize the energy
of a vacuum in the milk,
of an ultrasonic field,
of a kinetic energy of the sensor unit (4), and/or
of a kinetic energy of the transmitting and/or receiving unit (6);
(b3) the transmitting and/or receiving unit (6) has a timing circuit for setting waiting times until the activation of the signaling channel and/or traffic channel.

18. The device (1) as claimed in one of claims 12 to 17, characterized in that the transmitting an/or receiving unit (6) is configured as a passive transponder.

19. The device (1) as claimed in one of claims 12 to 18, characterized in that the traffic channel and/or the signaling channel have/has a time division multiplexor, a frequency division multiplexer and/or a code division multiplexer.

20. The device (1) as claimed in one of claims 11 to 19, characterized in that the transmitting an/or receiving unit (6) supports a packet-switched network, in particular a packet-switched network with an ALOHA access.

21. A milking installation, in particular a milking robot, comprising a multiplicity of milking cups (2), milk hoses (3) and at least one milk line (5), characterized by a device (1) as claimed in one of claims 11 to 19.

22. A herd management installation comprising a device as claimed in one of claims 12 to 20 and/or a milking installation as claimed in claim 21.
